(19) United States
(12) Patent Application Publication
(10) Pub. No.: US 2005/0084279 A1
(43) Pub. Date: Apr. 21, 2005

(54) Fusing roller used with image forming apparatus

(76) Inventors: Durk-hyun Cho, Suwon-si (KR); Hwan-guem Kim, Seoul (KR)

Correspondence Address: STANZIONE & KIM, LLP, 1740 N STREET, N.W., FIRST FLOOR, WASHINGTON, DC, 20036, US

(21) Appl. No.: 10/933,220

(22) Filed: Sep. 3, 2004

(30) Foreign Application Priority Data
Oct. 17, 2003 (KR) 2003-72502

(51) Int. Cl. G03G 15/00

(52) U.S. Cl. 399/90

(57) ABSTRACT

A fusing roller used with an image forming apparatus includes a fusing unit and a lamp installed in the fusing unit. The lamp includes a filament which generates heat, and a lead which is supplied with power by an external power supply, and a terminal which connects the lead and the external power supply so that the lead can be supplied with power by the external power supply. The terminal includes an alleviation unit which is elastically deformable so that deformation of the lead can be absorbed.

### CROSS-REFERENCE TO RELATED APPLICATIONS

This application claims the priority of Korean Patent Application No. 2003-72502, filed on Oct. 17, 2003, in the Korean Intellectual Property Office, the disclosure of which is incorporated herein in its entirety by reference.

### BACKGROUND OF THE INVENTION

1. Field of the Invention

The present general inventive concept relates to a fusing roller used with an image forming apparatus, and more particularly, to a fusing roller used with an image forming apparatus, in which a lamp is fixedly coupled to a terminal so that the lamp can be supplied with power by an external power supply.

2. Description of the Related Art

An image forming apparatus receives a digital image signal and transfers the digital image signal to a sheet of paper so that a visual image can be formed on the sheet of paper. In a process of forming the visual image on the sheet of paper, a developer receives the digital image signal and develops a latent electrostatic image formed on a photosensitive medium with toner. The developed toner image is transferred and fused onto the sheet of paper using a fusing roller, more particularly, using heat applied by the fusing roller, so that the visual image can be formed on the sheet of paper.

FIG. 1 is a schematic plan view illustrating a method of fixing a lamp 11 of a conventional fusing roller 10 to a terminal 15. Referring to FIG. 1, the fusing roller 10 directly contacts a toner image transferred onto a printing paper, fuses the toner image onto the printing paper, and includes the lamp 11 and a terminal 15 fixed to a frame (not shown) using a screw 16. The lamp includes a filament 12 which generates heat, a lead 14 supplied with current by an external power supply, and a foil 13 which connects the filament 12 and the lead 14, so that electricity can flow between the filament 12 and the external power supply.

The filament 12 is welded to the foil 13, and the lead 14 is welded to the foil 13 and the terminal 15.

The terminal 15, the lead 14, the foil 13, and the filament 12 are sequentially supplied with power by the external power supply. Then, the filament 12 is heated to a high temperature in a short period of time. The heat of the filament 12 is transferred to the fusing roller 10 via the lamp 11.

The filament 12 expands while generating the heat. Then, tensile stress from the expansion of the filament 12 is applied to the foil 13 and the lead 14. In particular, the tensile stress is highly concentrated on a welded area between the filament 12 and the foil 13, which is marked by a dotted circle in FIG. 1, and thus, the welded area becomes weakened. The tensile stress is also concentrated on welded areas between the foil 13 and the lead 14 and between the lead 14 and the terminal 15, which are marked by two other dotted circles in FIG. 1, and thus the welded areas become weakened, too. As the filament 12 cools down, it contracts. Accordingly, compression stress from the contraction of the filament 12 is applied to the foil 13 and the lead 14. As the filament 12 contracts, the compression stress is concentrated more and more on the welded area between the filament 12 and the foil 13, and thus the welded area becomes weakened. Likewise, the welded areas between the foil 13 and the lead 14 and between the lead 14 and the terminal 15 become weakened due to the concentration of the compression stress thereon.

Therefore, as the expansion and contraction of the filament 12 alternately occur, the tensile stress and the compression stress are alternately applied to the filament 12, the foil 13, the lead 14, and the terminal 15. Then, the welded areas between the filament 12 and the foil 13, between the foil 13 and the lead 14, and between the lead 14 and the terminal 15 become weakened more and more until they are cut in halves, in which case, the fusing roller 10 cannot be used.

### SUMMARY OF THE INVENTION

In order to solve the foregoing and/or other problems, it is an aspect of the present general inventive concept to provide a fusing roller used with an image forming apparatus, which is capable of preventing a lamp from being damaged or broken by absorbing tensile stress generating when the lamp thermally expands, and compression stress generating when the lamp cools down and contracts.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a fusing roller used with an image forming apparatus, the fusing roller including a fusing unit and a lamp installed in the fusing unit and further including a filament which generates heat, and a lead supplied with power by an external power supply, and a terminal which connects the lead and the external power supply so that the lead can be supplied with power by the external power supply, the terminal including an alleviation unit which is elastically deformable so that deformation of the lead can be absorbed.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plan view illustrating a method of fixing a lamp of a conventional fusing roller to a terminal;

FIG. 2 is a side view illustrating a fusing roller used with an image forming apparatus according to an embodiment of the present general inventive concept;

FIG. 3 is an enlarged perspective view illustrating an alleviation unit of FIG. 2;

FIGS. 4A through 4C are perspective views illustrating an alleviation unit of FIG. 2 according to another embodiment of the present general inventive concept;

FIG. 5 is a perspective view illustrating an operation of the alleviation unit of FIG. 2 when the fusing roller of FIG. 2 thermally expands; and

FIG. 6 is a perspective view illustrating an operation of the alleviation unit of FIG. 2 when the fusing roller of FIG. 2 thermally contracts.

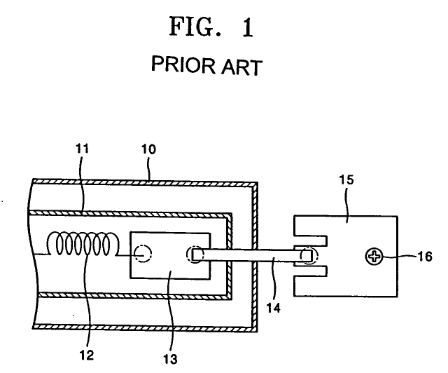

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

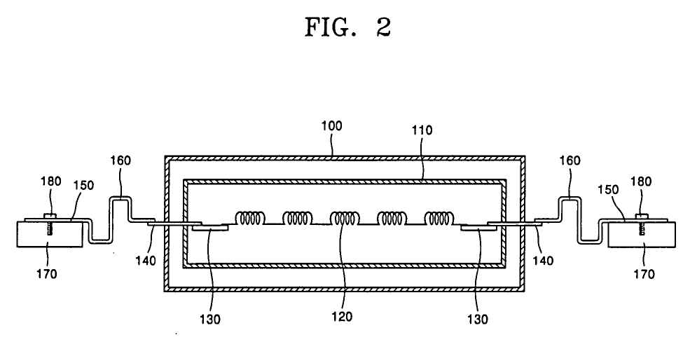

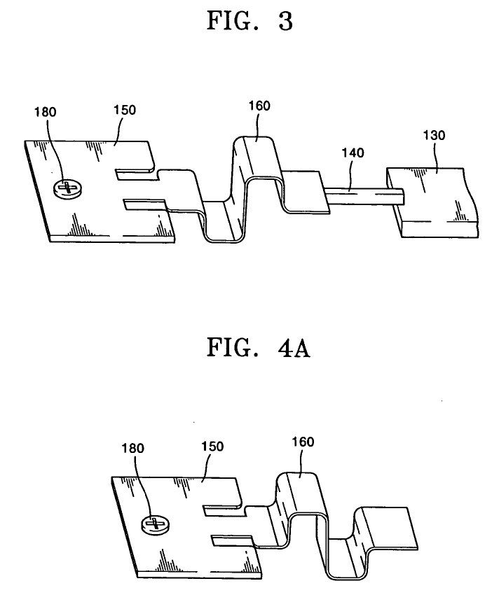

FIG. 2 is a side view illustrating a fusing roller according to an embodiment of the present general inventive concept, and FIG. 3 is an enlarged perspective view illustrating an alleviation unit 160 of FIG. 2. Referring to FIGS. 2 and 3, the fusing roller may include a fusing unit 100, a lamp 110, and a terminal 150.

An either end of the lamp 110 filled with halogen gas be hermetically sealed. The lamp 110 can be installed in the fusing unit 100. Foils 130 can be provided at either end of the lamp 110, and a filament 120 can be provided between the foils 130 to generate heat once it is supplied with power by an external power supply.

A lead 140 can be formed at one end of each of the foils 130 so that the lead 140 can protrude outside the fusing unit 100 passing through the lamp 110. The lead 140 can transmit the power between each of the foils 130 and the external power supply. The lead 140 can be hermetically formed through the lamp 110 and the fusing unit 100 so that the halogen gas filling an inside of the lamp 110 can be prevented from leaking through the lamp 110.

The alleviation unit 160 can be formed at either side of the fusing unit 100. The alleviation unit 160 can be supplied with power by the external power supply and can transmit the power to the lamp 110. One end of the alleviation unit 160 can be fixedly coupled to a frame 170 using a connecting unit, such as a screw 180, and the other side of the alleviation unit 160 can be electrically connected to the lead 140. The alleviation unit 160 can be formed to be capable of being elastically deformed so that it can absorb expansion and contraction of the lead 140 caused by heat transmitted from the filament 120.

As shown in FIG. 3, the alleviation unit 160 can be formed into a single body with the terminal 150. The alleviation unit 160 can be formed of an elastically deformable thin plate, which is bent in an ‘S’ shape.

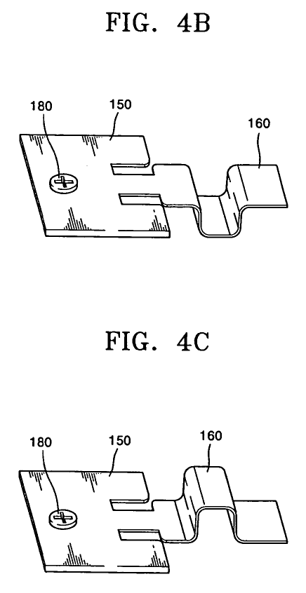

The alleviation unit 160, however, may have a different shape, i.e., an inverse ‘S’ shape (in FIG. 4A), a ‘U’ shape (in FIG. 4B), or a dome shape (in FIG. 4C). These variations of the alleviation unit 160 of FIG. 2 are also exemplary ones, so the alleviation unit 160 may assume various forms other than those set forth herein as long as it is formed to be elastically deformable.

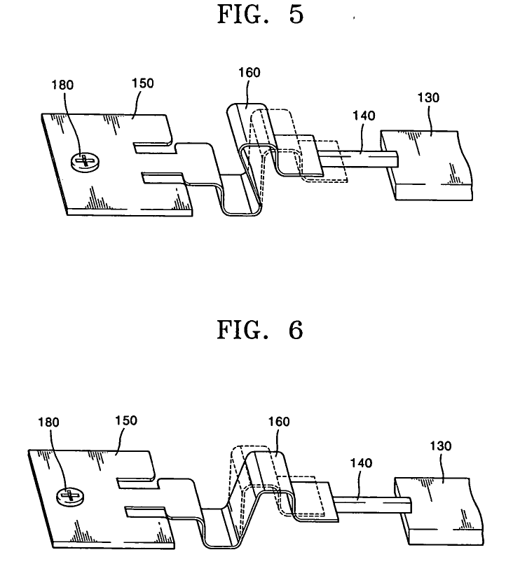

Different operations of the alleviation unit 160 when the lead 140 thermally expands and contracts will be described in greater detail in the following paragraphs with reference to FIGS. 5 and 6.

FIG. 5 is a perspective view illustrating an operation of the alleviation unit 160 when the lead 140 thermally expands, and FIG. 6 is a perspective view illustrating an operation of the alleviation unit 160 when the lead 140 thermally contracts.

Referring to FIGS. 2 and 6, the lead 150, power can be applied from the external power supply (not shown) to the filament 120 via the lead 150, the alleviation unit 160, the lead 140, and the foil 130. Once it is powered, the filament 120 can generate heat, and the heat can be transferred to the lamp 110 via the halogen gas filling the lamp 110 and to the fusing unit 100.

The heat generated by the filament 120 can also be transferred to the lead 140 via the foil 130, and thus the lead 140 thermally expands.

When the lead 140 thermally expands, the tensile stress can be applied to the alleviation unit 160, and thus the alleviation unit 160 can be elastically deformed. Therefore, the expansion of the lead 140 can be absorbed by the elastic deformation of the alleviation unit 160. As a result, the tensile stress can be prevented from being concentrated on connection areas between the lead 140 and the alleviation unit 160 and between the lead 140 and the foil 130. Even if the tensile stress is concentrated on the alleviation unit 160, the tensile stress can be absorbed by the alleviation unit 160 since the alleviation unit 160 is elastically deformable.

After a printing of documents or in a printing standby mode, the heat generated by the filament 120 fades away with the temperature of the filament 120 decreasing. Therefore, the amount of heat transferred from the filament 120 to the lead 140 also decreases, and thus the lead 140 contracts.

As the lead 140 contracts, the alleviation unit 160 also contracts. However, the contraction of the lead 140 can be absorbed by the elastic deformation of the alleviation unit 160. Thus, compression stress from the contraction of the lead 140 can be prevented from being concentrated on the connection areas between the lead 140 and the alleviation unit 160 and between the lead 140 and the foil 130 even if the compression stress is concentrated on the alleviation unit 160.

As described above, even if the lead 140 thermally expands or contracts due to the heat generated by the filament 120, the alleviation unit 160 can absorb the thermal deformation of the lead 140 by elastically deforming itself, and thus stress from the thermal deformation of the lead 140 can be prevented from being undesirably concentrated on the connection areas between the lead 140 and the alleviation unit 160 and between the lead 140 and the foil 130. Therefore, a lifetime and reliability of the fusing roller can be increased.

As described above, the fusing roller used with an image forming apparatus according to the above embodiment of the present general inventive concept can alleviate stress focused on weak electrical connecting portions because of repeated thermal expansions and contractions of a lead when power is applied thereto or cut off therefrom.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A fusing roller used with an image forming apparatus, comprising:
a fusing unit;
a lamp installed in the fusing unit and including a filament to generate heat, and a lead supplied with power by an external power supply; and
a terminal connected between the lead and the external power supply so that the lead can be supplied with power by the external power supply, and having an alleviation unit connected to the lead to be elastically deformable to absorb deformation of the lead.

2. The fusing roller of claim 1, wherein the alleviation unit is formed into a single integrated body with the terminal.

3. The fusing roller of claim 1, wherein the alleviation unit comprises an elastically deformable thin plate having a bent portion.

4. The fusing roller of claim 3, wherein the bent portion of the alleviation unit is formed in an ‘S’ shape.

5. The fusing roller of claim 3, wherein the bent portion of the alleviation unit is formed in a ‘U’ shape.

6. A fusing roller used with an image forming apparatus, comprising
a fusing unit having a lamp and a lead protruding from the lamp;
a terminal; and
an alleviating unit connected between the terminal and the lead of the fusing unit and elastically deformed with respect to at least one of the terminal and the lead of the fusing unit.

7. The fusing roller of claim 6, wherein the lead is disposed on a line passing through the lamp, and the alleviating unit comprises a bent portion having an angle with the line.

8. The fusing roller of claim 6, wherein the alleviating unit comprises two plates bent with respect to the lead.

9. The fusing roller of claim 6, wherein the alleviating unit comprises a first end electrically connected to the terminal, a second end electrically connected to the lead of the lamp, and a bent portion bent with respect to at least one of the first end and the second end.

10. The fusing roller of claim 9, wherein the bent portion is bent according to thermal expansion and contraction of the lead of the lamp.

11. The fusing roller of claim 9, wherein the first end of the alleviating unit is disposed on a line on which the terminal is disposed.

12. The fusing roller of claim 10, wherein the second end of the alleviating unit is disposed on a line on which the lead of the lamp is disposed.

13. The fusing roller of claim 10, wherein the bent portion comprises a first plate extended from the first end and having a first angle with the first end, a second plate extended from the second end and having a second angle with the second end, and a third plate connected between the first plate and the second plate.

14. The fusing roller of claim 13, wherein the first plate and the second plate are disposed parallel to each other.

15. The fusing roller of claim 13, wherein the first angle and the second angle vary depending on a temperature of the lead of the lamp.

16. The fusing roller of claim 13, wherein the third plate is in a round shape with respect to the first end and the second end of the bent portion.

17. The fusing roller of claim 13, wherein the first plate, the second plate, and the third plate move with respect to at least one of the terminal and the lead of the lamp to absorb tensile stress and compression stress generating according to a temperature of the lead of the lamp.

18. The fusing roller of claim 13, wherein the first plate and the second plate move wit respect to at least one of the first end and the second end of the bent portion while the terminal do not move with respect to the lamp.

19. The fusing roller of claim 6, wherein the terminal does not move with respect to the lamp of the fusing unit, and the alleviation unit comprises a portion movable with respect to the lamp of the fusing unit according to a temperature of the lead.

20. An image forming apparatus comprising;
a frame; and
a fusing roller comprises,
a fusing unit a lamp and a lead protruding from the lamp,
a terminal fixedly connected to the frame, and
an alleviating unit connected between the terminal and the lend of the fusing unit and elastically deformed with respect to at least one of the terminal and the lead of the fusing unit to absorb deformation of the lead of the lamp.
